(19) United States
(12) Patent Application Publication
(10) Pub. No.: US 2019/0076765 A1
(43) Pub. Date: Mar. 14, 2019

(54) PRE-FILTER FOR REMOVAL OF CESIUM AND METHOD OF MANUFACTURING SAME

(71) Applicants: PICOGRAM CO., LTD., Incheon (KR); KOREA ATOMIC ENERGY RESEARCH INSTITUTE, Daejeon (KR)

(72) Inventors: Sung Taek LIM, Gimpo-si (KR); Hyun Ki HONG, Incheon (KR); Mi Lim BYUN, Incheon (KR); Chang Hyun ROH, Daejeon (KR)

(73) Assignees: PICOGRAM CO., LTD., Incheon (KR); KOREA ATOMIC ENERGY RESEARCH INSTITUTE, Daejeon (KR)

(21) Appl. No.: 16/124,665

(22) Filed: Sep. 7, 2018

(30) Foreign Application Priority Data
Sep. 11, 2017 (KR) 10-2017-0115931

(51) Int. Cl. B01D 39/16; B01D 39/20; B01J 20/28; B01J 20/30; B01J 20/26; B01J 20/02

(52) U.S. Cl. CPC B01D 39/16; B01D 39/2068; B01J 20/2803; B01J 20/3007; B01J 20/3078; B01J 20/3042; B01J 2220/46; B01J 20/0229; B01D 2239/0407; B01D 2257/60; B01D 2239/10; B01D 2239/08; B01J 20/261

(57) ABSTRACT

The present invention relates to a pre-filter for removal of cesium and a method of manufacturing the same. The pre-filter for removal of cesium includes ultra-high-molecular-weight polyethylene and a cesium adsorbent, and is manufactured in which the ultra-high-molecular-weight polyethylene and the cesium adsorbent are mixed, heated, and molded or the ultra-high-molecular-weight polyethylene and the cesium adsorbent are mixed, molded, and heated. The pre-filter manufactured thereby removes cesium excellently and has excellent impact resistance, abrasion resistance, slipperiness, and chemical resistance.

### CROSS-REFERENCE TO RELATED APPLICATIONS

The present application claims priority to Korean Patent Application No. 10-2017-0115931, filed Sep. 11, 2017, the entire contents of which is incorporated herein for all purposes by this reference.

### FIELD

The present invention relates to a pre-filter for removal of cesium and a method of manufacturing the same. More particularly, the present invention relates to a pre-filter for removal of cesium and method of manufacturing same, the pre-filter removing cesium excellently and having excellent impact resistance, abrasion resistance, slipperiness, and chemical resistance.

### BACKGROUND

Tap water supplied to each household is cleanly purified water provided from a strictly controlled water treatment plant, but purified water is contaminated in a process of being supplied from the water treatment plant through water pipes. The water pipes are made of a corrosive metal and it is difficult to replace an old water pipe used for long periods of time with a new one such that tap water supplied through the old water pipe is contaminated.

Therefore, at least one pre-filter is installed in a water purification apparatus such as a household water purifier and a bidet. Pre-filters include a sediment pre-filter and a pre-carbon filter. The sediment pre-filter serves to remove impurities such as rust, soil, sand, dust, and other impurities to maximize the effect of water purification from the initial stage, and the pre-carbon filter serves to remove odor and organic chemicals such as trihalomethane (THM) which may be generated by a chlorine component added for the disinfection of tap water.

The pre-filter may be configured to be used in a form of a series connection of filters having respective functions, or in a form of a complex filter capable of performing various functions simultaneously if necessary.

In addition to removing impurities such as rust, soil, sand, and dust, the pre-filter also includes iodinated resin, which kills bacteria contained in tap water and inactivates viruses in order to perform sterilization.

Iodinated resin is complexion of strongly basic anion exchange resin and iodide ions. The iodinated resin is a stable compound, has very low solubility in water, and has excellent sterilizing power. In addition, the iodinated resin has advantages of continuous sterilizing power, easy installation, and low cost.

Furthermore, the iodinated resin does not leave harmful residues in the water that passes through, and a sterilizing action occurs simultaneously with the supply of water such that it is advantageous in providing clean water safely at any time. However, there is a problem that performance of filtering out components such as cesium is insufficient.

### SUMMARY

Accordingly, the present invention has been made keeping in mind the above problems occurring in the related art, and an object of the present invention is to propose a pre-filter for removal of cesium and method of manufacturing same, the pre-filter removing cesium excellently and having excellent impact resistance, abrasion resistance, permeability, and chemical resistance.

In order to achieve the above object, the present invention provides a pre-filter for removal of cesium, the filter including ultra-high-molecular-weight polyethylene and a cesium adsorbent.

The pre-filter for removal of cesium may include 100 parts of weight of the ultra-high-molecular-weight polyethylene and 1 to 100 parts by weight of the cesium adsorbent.

The cesium adsorbent may be composed of Prussian blue.

In addition, in order to achieve the above object, the present invention provides a method of manufacturing a pre-filter for removal of cesium, the method includes: preparing a mixture in which 100 parts of weight of ultra-high-molecular-weight polyethylene and 1 to 100 parts by weight of cesium adsorbent; heating the mixture prepared at the preparing to a temperature ranging from 100° C. to 300° C.; and compress-molding the mixture heat-treated at the heating to a pressure ranging from 2 kgf/cm² to 6 kgf/cm².

Furthermore, in order to achieve the above object, the present invention provides a method of manufacturing a pre-filter for removal of cesium, the method including: preparing a mixture in which 100 parts of weight of ultra-high-molecular-weight polyethylene and 1 to 100 parts by weight of cesium adsorbent are mixed; compress-molding the mixture prepared at the preparing to a pressure ranging from 2 kgf/cm² to 6 kgf/cm²; and heating the mixture molded at the compress-molding to a temperature ranging from 100° C. to 300° C.

According to the pre-filter for removal of cesium and the method of manufacturing the same as described above, the pre-filter removes cesium excellently and has excellent impact resistance, abrasion resistance, slipperiness, and chemical resistance.

### DRAWINGS

The above and other objects, features and other advantages of the present invention will be more clearly understood from the following detailed description when taken in conjunction with the accompanying drawings, in which:

FIG. 1 is a flowchart illustrating a method of manufacturing a pre-filter for removal of cesium according to an embodiment of the present invention;

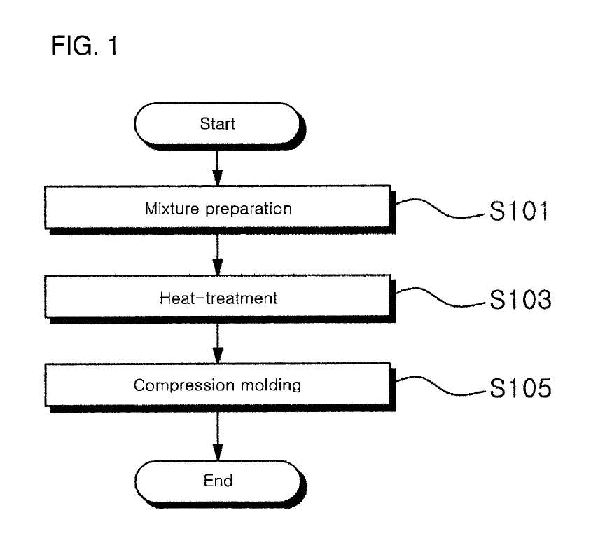

FIG. 2 is a flowchart illustrating a method of manufacturing a pre-filter for removal of cesium according to another embodiment of the present invention;

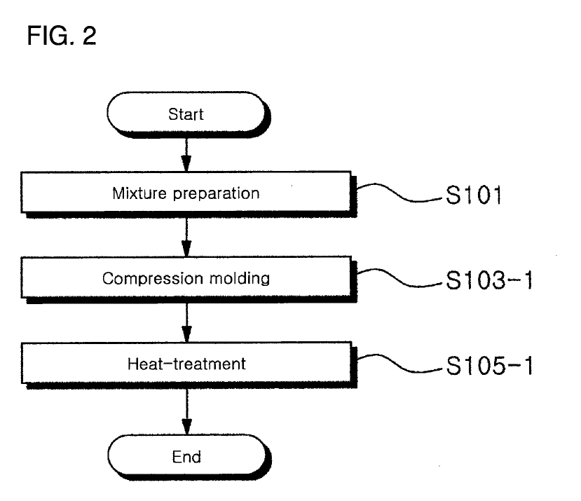

FIG. 3 is a schematic view illustrating that Prussian blue adsorbs cesium, the Prussian blue contained in the pre-filter for removal of cesium according to the present invention;

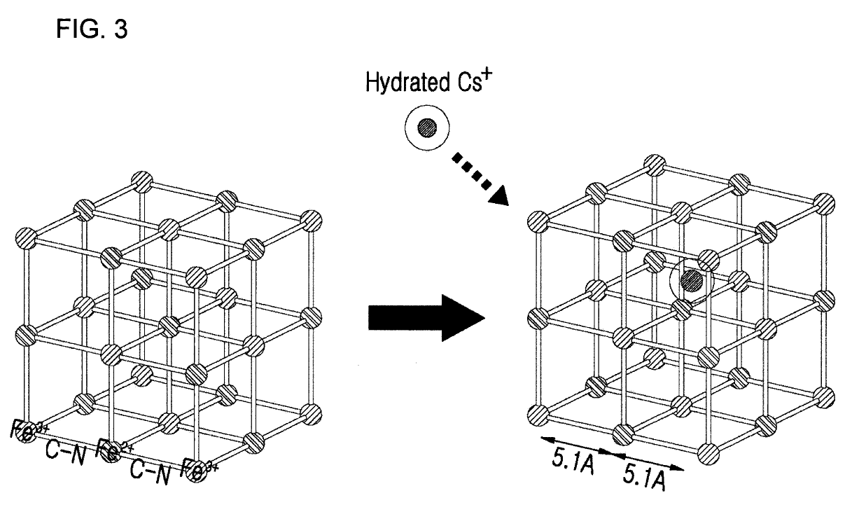

FIG. 4 is a graph illustrating cesium removal performance of a pre-filter prepared in Example 1 of the present invention;

FIG. 5 is a graph illustrating cesium removal performance of a pre-filter prepared in Example 2 of the present invention;

FIG. 6 is a graph illustrating cesium removal performance of a pre-filter prepared in Example 3 of the present invention;

FIG. 7 is a graph illustrating cesium removal performance of a pre-filter prepared in Comparative Example 1 of the present invention; and

FIG. 8 is a photograph illustrating the pre-filters prepared in Examples 1 to 3 and Comparative Example 1 of the present invention.

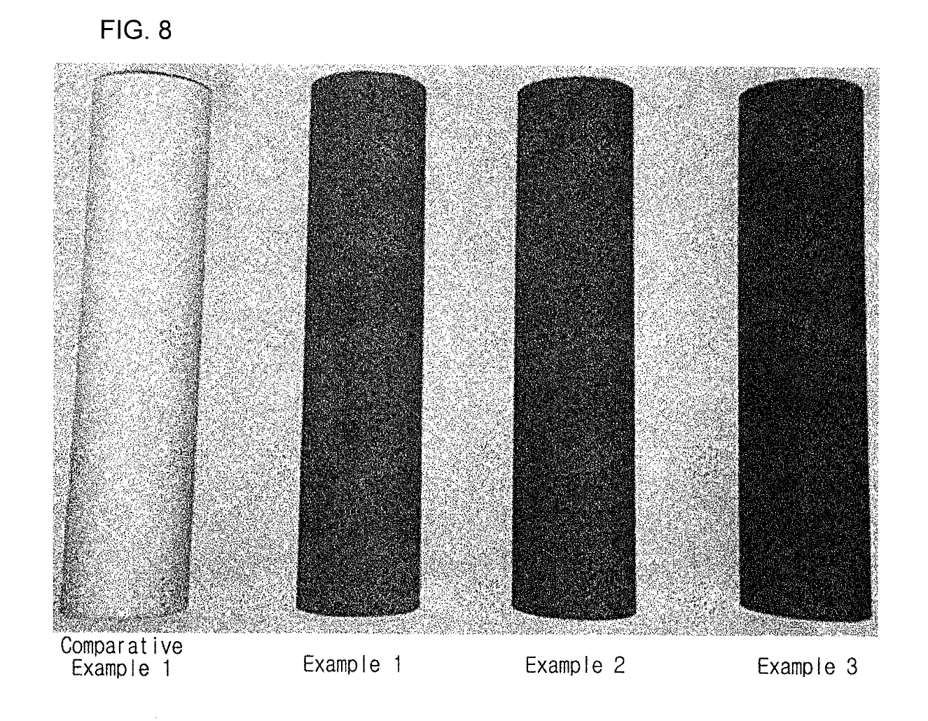

### DETAILED DESCRIPTION

Hereinbelow, preferred embodiments of the present invention will be described in detail with reference to the accompanying drawings. The invention is intended to be easily embodied by one of ordinary skill in the art to which this invention belongs, and is not meant to limit the spirit and scope of the invention.

A pre-filter for removal of cesium includes ultra-high-molecular-weight polyethylene and cesium adsorbent. The pre-filter for removal of cesium may include 100 parts of weight of the ultra-high-molecular-weight polyethylene and 1 to 100 parts by weight of the cesium adsorbent.

The ultra-high-molecular-weight polyethylene is a main raw material of the pre-filter to serve as a binder holding the cesium adsorbent.

When the ultra-high-molecular-weight polyethylene is applied as a binder as described above, the pre-filter is improved in impact resistance, abrasion resistance, slipperiness, and chemical resistance such that the pre-filter exhibits excellent durability. Thus, a filter can be provided which maintains the water purification performance for long periods of time.

Specifically, as the ultra-high-molecular-weight polyethylene, it is preferable to use GUR produced by Ticona GmbH, Germany, wherein the GUR has a molecular weight of about 300 to 1000.

The cesium adsorbent is contained in the pre-filter by 1 to 100 parts by weight and serves to impart cesium adsorption performance to the pre-filter for removal of cesium of the present invention. The cesium adsorbent may be composed of Prussian blue.

The Prussian blue falls into two types depending on the solubility in water. In general, the Prussian blue is formed by a combination of Fe³⁺ and [Fe^{II}(CN)₆]⁴⁻ or a combination of Fe²⁺ and [Fe^{III}(CN)₆]³⁻.

Typically, insoluble Prussian blue is represented by Fe^{III}₄[Fe^{II}(CN)₆]₃ and soluble Prussian blue is represented by KFe^{III}[Fe^{II}(CN)₆].

Each formation process of the two types of Prussian blue is shown in following Reaction Equations 1 and 2, respectively.

4Fe³⁺+3[Fe^{II}(CN)₆]⁴⁻→Fe₄^{III}[Fe^{II}(CN)₆]₃ Reaction Equation 1

K⁺+Fe³⁺+[Fe^{II}(CN)6]⁴⁻→KFe_{III}[Fe^{II}(CN)₆] Reaction Equation 2

The adsorption performance of Prussian blue for alkali metal ions is related to Stokes radii of the alkali metal ions as hydrated ions, where the adsorption performance of Prussian blue for alkali metal ions is exhibited in the order of Cs+>>K+≥Na+. This is because Prussian blue exhibits high adsorption performance with an ion among the alkali metal ions, the ion having a Stokes radius fitted in Prussian blue lattice spaces. The Stokes radii of the alkali ions are Cs+(1.19)<K+(1.25)<Na+(1.84 Å) and the smallest Stokes radius of Cs+ is fitted well and trapped in Prussian blue lattice spaces in size. Accordingly, the cesium adsorbent composed of Prussian blue serves to selectively adsorb cesium.

In addition, the Prussian blue lattice is filled with coordination water molecules to form hydrophilic spaces. Hydrated Cs+ ions prefer to be adsorbed in such hydrophilic spaces of Prussian blue. When Cs+ ions occupy the hydrophilic spaces, Cs+ ions are efficiently adsorbed by proton-exchange mechanism of coordination water molecule of Fe(III), which is shown in the following Reaction Equation 3:

Fe^{III}—OH₂+Cs⁺A⁻→{Fe^{III}—OH}⁻Cs⁺+H⁺A⁻ Reaction Equation 3

Accordingly, as shown in Reaction Equation 3, Cs+ ions are effectively adsorbed in Prussian blue lattice spaces by proton-exchange.

In addition, insoluble Prussian blue shown in the above Reaction Equation 1 is suitable as a cesium adsorbent because insoluble Prussian blue can be easily recovered through a recovery process.

When the content of the cesium adsorbent is less than 1 part by weight, the above-mentioned effects are insignificant. On the other hand, when the content of the cesium adsorbent exceeds 100 parts by weight, the contents of the ultra-high-molecular-weight polyethylene is relatively reduced, leading to deterioration of the water purification performance and the durability of the pre-filter.

A method of manufacturing a pre-filter for removal of cesium according to an embodiment of the present invention includes: preparing a mixture (S101) in which 100 parts by weight of ultra-high-molecular-weight polyethylene and 1 to 100 parts by weight of a cesium adsorbent are mixed; heating the mixture prepared at the preparing step S101 to a temperature ranging from 100° C. to 300° C. (S103); and compress-molding the mixture heat-treated at the heating step S103 to a pressure ranging from 2 kgf/cm² to 6 kgf/cm² (S105).

At the preparing step S101, the ultra-high-molecular-weight polyethylene and the cesium adsorbent are mixed together. Specifically, with use of a precision digital scale (CB-3000), 100 parts by weight of the ultra-high-molecular-weight polyethylene and 1 to 100 parts by weight of the cesium adsorbent are mixed, and the mixture is prepared by using a ribbon blender for 10 minutes to 20 minutes.

Here, the components and roles of the ultra-high-molecular-weight polyethylene and the cesium adsorbent are the same as those described in the pre-filter for removal of cesium, and thus a description thereof will be omitted.

At the heating step S103, the mixture obtained from the preparing step S101 is heated at a temperature ranging from 100° C. to 300° C. for 20 minutes to 60 minutes. After the heating step S103, moisture and various impurities contained in the mixture prepared obtained from the preparing step S101 are removed.

At the compress-molding step S105, the mixture heat-treated at the heating step S103 to a pressure ranging from 2 kgf/cm² to 6 kgf/cm². The mixture heat-treated at the heating step S103 is transferred to a compression molding block, bound to a compression molding machine, and compressed at a pressure of 2 kgf/cm² to 6 kgf/cm² for 8 seconds to 12 seconds.

On the other hand, a method of manufacturing a pre-filter for removal of cesium according to another embodiment of the present invention includes: preparing a mixture (S101) in which 100 parts by weight of ultra-high-molecular-weight polyethylene and 1 to 100 parts by weight of a cesium adsorbent are mixed; compress-molding the mixture prepared at the preparing step S101 to a pressure ranging from 2 kgf/cm² to 6 kgf/cm² (S103-1); and heating the mixture molded at the compress-molding step S103-1 to a temperature ranging from 100° C. to 300° C. (S105-1).

Here, the specific conditions of the preparing step S101, the compress-molding step S103-1, and the heating step S105-1 are the same as the preparing step S101, the heating step S103, and the compress-molding step S105 which are described above, and thus a description thereof will be omitted.

Hereinafter, the method of manufacturing the pre-filter for removal of cesium according to the present invention and physical properties of the pre-filter for removal of cesium manufactured by the method will be described by way of examples.

### Example 1

95 g of ultra-high-molecular-weight polyethylene (GUR-4022 from Ticona Company) and 5 g of Prussian blue (insoluble Iron ^{III} ferrocyanide from Sigma-Aldrich Company) were weighed using a precision digital scale (CB-3000), put into a 1000 ml beaker and mixed for 15 minutes using a ribbon blender. The mixture was placed in a laboratory heater maintained at a temperature of 130° C. and heated for 30 minutes. The heat-treated mixture was transferred to a compression molding block, bound to a compression molding machine, and compressed at a pressure of 2.5 kgf/cm² for 10 seconds such that a pre-filter for removal of cesium was prepared.

### Example 2

A pre-filter for removal of cesium was prepared in the same manner as in Example 1, except that 90 g of the ultra-high-molecular-weight polyethylene (GUR-4022 from Ticona Company) and 10 g of Prussian blue (insoluble Iron ^{III} ferrocyanide from Sigma-Aldrich Company) were used.

### Example 3

A pre-filter for removal of cesium was prepared in the same manner as in Example 1, except that 80 g of the ultra-high-molecular-weight polyethylene (GUR-4022 from Ticona Company) and 20 g of Prussian blue (insoluble Iron ^{III} ferrocyanide from Sigma-Aldrich Company) were used.

### Comparative Example 1

A pre-filter for removal of cesium was prepared in the same manner as in Example 1, except that only the ultra-high-molecular-weight polyethylene was used.

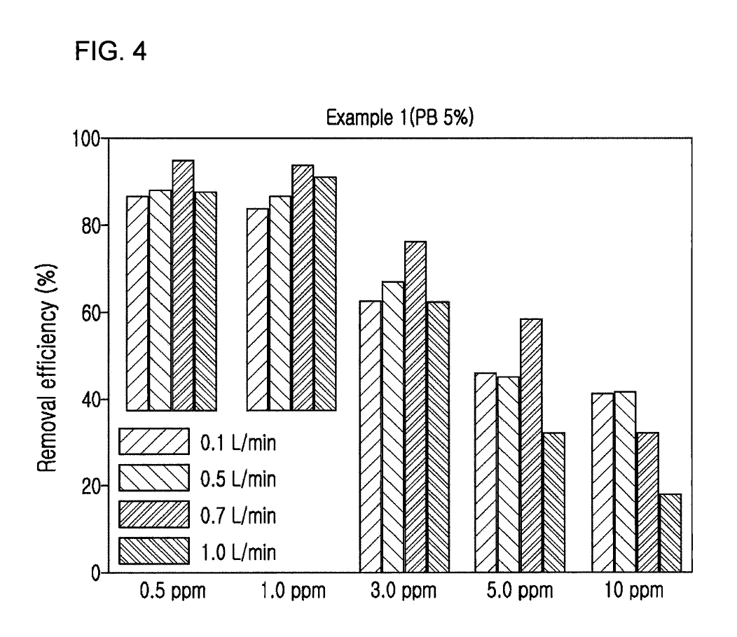

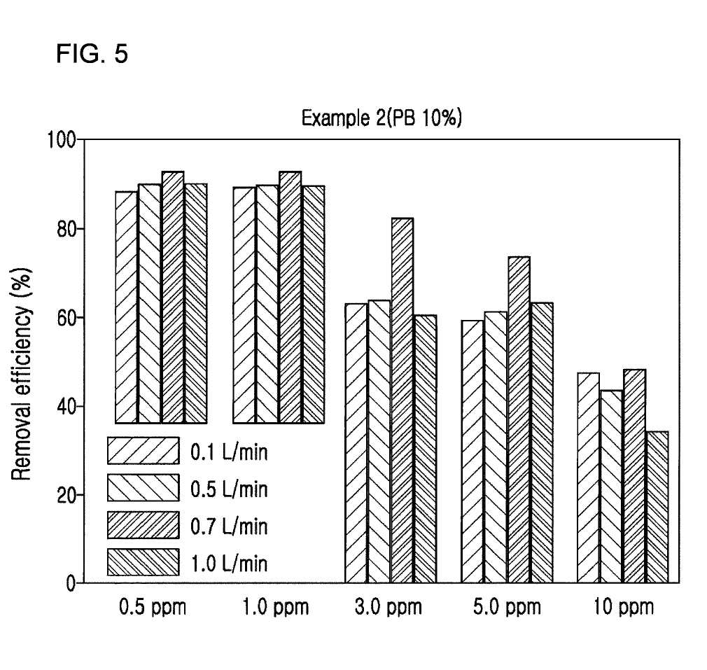

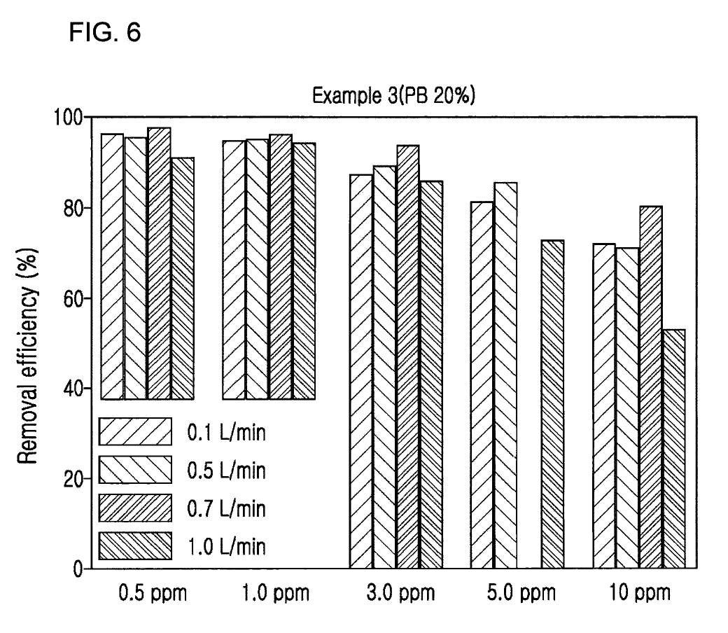

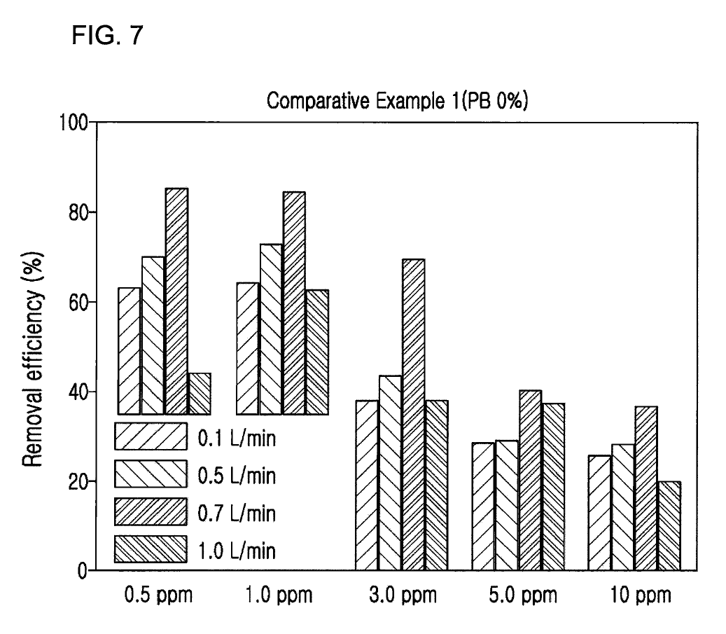

Cesium removal performance of the pre-filters for removal of cesium prepared in Examples 1 to 3 and the pre-filter prepared in Comparative Example 1 were measured and shown in below Table 1 and FIGS. 4 to 7.

A solution was prepared by dissolving cesium nitrate (Sigma-Aldrich Company) in distilled water. The cesium removal performance of the filter was prepared under conditions of cesium concentration (0.5 ppm, 1 ppm, 3 ppm, 5 ppm, and 10 ppm) of the solution because a separate process test for the cesium removal efficiency of the filter was not designated. In order to evaluate the performance of the filter according to a flow rate of inflow water, flow rate conditions were 0.1 L/min, 0.5 L/min, 0.7 L/min, and 1 L/min.

In addition, the solution was introduced into a tank of a performance tester and passed through the performance tester with the pre-filters of Examples 1 to 3 and Comparative Example 1, respectively. Cesium removal performance of the purified water undergoing the different conditions was checked out by ICP analysis.

TABLE 1

| | | Example 1 (PB 5%) | | | | Example 2 (PB 10%) | | | |
|---|---|---|---|---|---|---|---|---|---|
| Concentration | Blank | 0.1 L/min | 0.5 L/min | 0.7 L/min | 1.0 L/min | 0.1 L/min | 0.5 L/min | 0.7 L/min | 1.0 L/min |
| 0.5 ppm | 0.3593 | 0.0352 | 0.0312 | 0.0103 | 0.0336 | 0.0291 | 0.0233 | 0.0146 | 0.0214 |
| 1.0 ppm | 0.8278 | 0.1137 | 0.0848 | 0.0338 | 0.0592 | 0.0566 | 0.0504 | 0.0338 | 0.0487 |
| 3.0 ppm | 2.0870 | 0.7336 | 0.6336 | 0.4409 | 0.7516 | 0.7013 | 0.6767 | 0.2971 | 0.7561 |
| 5.0 ppm | 3.5119 | 1.8027 | 1.8252 | 1.4314 | 2.3051 | 1.3189 | 1.2268 | 0.8418 | 1.1800 |
| 10 ppm | 6.4085 | 3.6181 | 3.5972 | 4.1982 | 5.1234 | 3.1308 | 3.3555 | 3.1222 | 4.0064 |

| | | | | | Comparative | | | |
|---|---|---|---|---|---|---|---|---|
| | Example 3 (PB 20%) | | | | Example 1 (PB 0%) | | | |
| Concentration | 0.1 L/min | 0.5 L/min | 0.7 L/min | 1.0 L/min | 0.1 L/min | 0.5 L/min | 0.7 L/min | 1.0 L/min |
| 0.5 ppm | 0.0107 | 0.0113 | 0.0079 | 0.0280 | 0.1261 | 0.1035 | 0.0371 | 0.1948 |
| 1.0 ppm | 0.0348 | 0.0332 | 0.0239 | 0.0403 | 0.2711 | 0.2076 | 0.0971 | 0.2786 |
| 3.0 ppm | 0.2517 | 0.2120 | 0.1022 | 0.2651 | 1.2795 | 1.1494 | 0.5924 | 1.2698 |
| 5.0 ppm | 0.5743 | 0.4654 | — | 0.9976 | 2.5175 | 2.5049 | 2.1051 | 2.2068 |
| 10 ppm | 1.8311 | 1.8850 | 1.1584 | 2.9612 | 4.8111 | 4.6407 | 4.1680 | 5.0104 |

As shown in Table 1 and FIGS. 4 to 7, the pre-filters for removal of cesium prepared according to Examples 1 to 3 of the present invention removed cesium excellently as compared to the pre-filter prepared according to Comparative Example 1.

Accordingly, the pre-filter for removal of cesium of the present invention and the method of manufacturing the same provide a pre-filter that removes cesium excellently and maintains water purification performance for long periods of time.

What is claimed is:

1. A pre-filter for removal of cesium, the filter comprising: ultra-high-molecular-weight polyethylene and cesium adsorbent.

2. The filter of claim 1, comprising:
100 parts of weight of the ultra-high-molecular-weight polyethylene and 1 to 100 parts by weight of the cesium adsorbent.

3. The filter of claim 1, wherein the cesium adsorbent is composed of Prussian blue.

4. A method of manufacturing a pre-filter for removal of cesium, the method comprising:
preparing a mixture in which 100 parts of weight of ultra-high-molecular-weight polyethylene and 1 to 100 parts by weight of cesium adsorbent are mixed;
heating the mixture prepared at the preparing to a temperature ranging from 100° C. to 300° C.; and
compress-molding the mixture heat-treated at the heating to a pressure ranging from 2 kgf/cm² to 6 kgf/cm².

5. A method of manufacturing a pre-filter for removal of cesium, the method comprising:
preparing a mixture in which 100 parts of weight of ultra-high-molecular-weight polyethylene and 1 to 100 parts by weight of cesium adsorbent are mixed;
compress-molding the mixture prepared at the preparing to a pressure ranging from 2 kgf/cm² to 6 kgf/cm²; and
heating the mixture molded at the compress-molding to a temperature ranging from 100° C. to 300° C.

6. The filter of claim 2, wherein the cesium adsorbent is composed of Prussian blue.
